(19) United States
(12) Patent Application Publication
(10) Pub. No.: US 2008/0168546 A1
(43) Pub. Date: Jul. 10, 2008

(54) RANDOMIZED IMAGES COLLECTION METHOD ENABLING A USER MEANS FOR ENTERING DATA FROM AN INSECURE CLIENT-COMPUTING DEVICE TO A SERVER-COMPUTING DEVICE

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/621,939

(22) Filed: Jan. 10, 2007

(51) Int. Cl. G06F 21/00; G06F 3/048

(52) U.S. Cl. 726/6; 726/18; 715/773

(57) ABSTRACT

A randomized images collection along with user's images credential and having underlying credential values are transmitted from a server-computing device to a client-computing device where a user at the client-computing device is to login and be authenticated by the server-computing device. The randomized images collection will provide a secure mechanism for end users to login into a server-computing device from an insecure client-computing device and provide security against spyware and phishing attack, by not allowing spyware software way of recording the user interaction at the client-computing device, nor allowing phishing attack on the website.

### BACKGROUND OF INVENTION

1. Field of the Invention

The field of this invention relates generally to a method for a highly secure virtual credentials for a user to login to a server using a randomizing images collection supplied and/or user-selected images or a combination of images and keys to thwart sypware and phishing.

2. Prior Art

Prior art Montgomery at al U.S. application Ser. No. 11/076,682 teaches a randomized keypad where a server creates an image map with randomized images and save them for the duration of the session, the randomized images are sent to a requesting client computer and they represent the key's values where either the X-Y coordinates of the images or the assigned keypad values for the images are matched against a table stored at the server or against the actual PIN value also stored therefore. At the client computer side a user clicks over the images that represents the key value, the value is recorded at a hidden form array and after a user selects the done/sign on button, the form array values are sent to the server, at the server, the values are matched against the table or against the actual PIN and a verification is done from the user clicked image values to the actual PIN value. Montgomery at al also teaches a virtual key input method where a user pre-assign a formula and applies a computation of the actual PIN with a preset extended key then typing into the input field a virtual value that once received by the server it will apply the virtual value along with the extended value to the user's formula and derive the actual PIN.

Although Montgomery at al teaches a randomized image keypad with values representation of a PIN stored in the server side and a virtualization means for entering a virtual PIN, however the prior art fails to teach any security means for thwarting phishing attack, since anyone with the skill in the art will readily be able to implement Montgomery at al's invention on the server side and send a fake page to unsuspecting users and have the same mechanism to decipher the user clicked images and make known the user's PIN. Furthermore, Montgomery at al fails to teach a real virtual means without the user being highly skilled in the field of mathematics; hence, it fails to teach a simple means for entering sensitive user's information without a high degree of complexity.

It is the intent of the present invention to offer a highly secure virtual credential means for login in into a network and entering user's sensitive information by using randomized images collection to prevent phishing and spyware attacks.

### SUMMARY OF THE INVENTION

It is the object of this invention to use a randomized images collection along with user's images credentials, a virtual credential authorization mechanism providing a highly secure means for a user to login into a server, also, to enter any type of sensitive information that requires security against spyware and phishing attack. Furthermore, a randomized virtual credential means for providing authentication means to various locations using a single credential without jeopardizing security.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates a preferred embodiment of this invention with a credential field, a randomized keypad with images, a sign on and a clear buttons and a client side JavaScript.

FIG. 2 illustrates a server/client communication over the Internet/network and the randomized keypad shown at the client computer display means FIG. 3 illustrates HTML (Hyper Text Markup Language) blocks representing the embodiment of FIG. 1.

FIG. 3a illustrates a JavaScript code representing the embodiment of FIG. 1.

FIG. 4 illustrates two users making use of the credential login using a randomized image collection.

FIG. 5 illustrates the randomized images collection of FIG. 4 with randomized virtual credentials.

FIG. 6 illustrates different ways of using the randomized credential.

FIG. 7 illustrates ways for using a single randomized virtual credential for various authentication locations.

### DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As will be appreciated by those of skill in the art, the present invention may be embodied as a method or a computer program product. Accordingly, the present invention may take a form of an entirely software embodiment or an embodiment combining software and hardware. Furthermore, the present invention may take the form of a computer program product on a computer-readable storage medium having computer-readable program code means embodied in the medium. Any computer readable medium may be utilized including but not limited to: hard disks, CD-ROMs, optical storage devices, or magnetic devices.

Also, any reference to names of a product or of a company is for the purpose of clarifying our discussion and they are registered to their respective owners.

In a preferred embodiment the invention provides a system and method allowing a user to securely log in to a server using an insecure system without imposing the risks of having the user's PIN, password exposed to sniffing attacks, keyboard logging, shoulder surfing, or similar methods of attack.

With today's global information at anyone's disposal over the Internet, security is always a major concern. In the past users usually dealt with a single location for his/her transaction and they were static in nature. With the advent of the Internet, all that has changed because the Internet is a Global network and anyone anywhere can take advantage of it and some use it for criminal activities and they can come in many forms. There are two well-known type of attack used for malicious purpose and they can be done from anywhere on the Internet by simply taking advantage of user's lack of understanding, security flaws in the website or the user client web browser, server software backdoor, operating system security flaws, open network nature of the Internet, etc., and they are: spyware, malware, adware (henceforth called spyware) and phishing.

Spyware is computer software that collects personal information about users without their informed consent. Personal information is secretly recorded with a variety of techniques, including logging keystrokes, mouse clicks, recording Internet web browsing history, and scanning documents on the computer's hard disk. Their purposes range from overtly criminal (theft of credentials and financial details) to the merely annoying (recording Internet search history for targeted advertising, while consuming computer resources). Spyware may collect different types of information. Some variants attempt to track the websites a user visits and then send this information to an advertising agency. More malicious variants attempt to intercept credentials or credit card numbers as a user enters them into a web form or other application.

Once a spyware is active at a particular computer all the user's activities at the computer are compromised even if the computer communicates with a server computer using secure communication channel like HTTPS (Hyper Text Transfer Protocol Security). Because of the fact that a spyware records user's activity at the computer where they are active and before the actual activity is sent to a connected server, thus, HTTPS is of no avail against such attacks.

Phishing is a criminal activity using social engineering techniques. Phishers attempt to fraudulently acquire sensitive information, such as passwords and credit card details, by masquerading as a trustworthy person or business in an electronic communication. Phishing is typically carried out using email or an instant message. Attempts to deal with the growing number of reported phishing incidents include legislations, user training, and technical measures. Some sites have created a means to thwart users from phishing attack and it involves an image the user selects for the purpose of identifying its authenticity. If the site that is requesting user's information doesn't have the user selected image the user will know that the site is fake and it is a phishing attack.

It is the objective of this invention to provide a method for login into a computer that will not allow spyware or phishing to pry on users and steal the user's information nor allow shoulder surfers any way for guessing the credentials by following the mouse movement from a distance.

Henceforth follows a more detailed descriptive discussion of the present invention. Once a user registers with a server computer the user will either select a collection of images from the server; user will upload a collection of images to the server, or the server will assign a collection of images to the user—henceforth this process is called images collection or keypad (used interchangeably), this term will be used to refer to the images collection along with the user's image credentials as well. The server will either generate a credential value to each image of the images collection; use values previously assigned by the server, or, as in other embodiments the user will be allowed to provide values for each image of the image collection—henceforth called credential values. The user will either select a number of images from the collection for the purpose of creating the user's login credential with the server—henceforth called user credential or user images credential, used here interchangeably. Once a server computing device randomizes a images collection for transmission to a client computer device, the server computing device may send the actual credential value for each image of the images collection or the server computing device may assign virtual credential values and have the virtual credential values mapped with the actual credential values stored at the server computing device then send the virtual credential with the images collection to the client computing device.

In response to a request to access a server computing device the server computing device is operated to generate a images collection placed at random positions along with images representing the user credential, each image of the image collection corresponding to a possible value of the credential value in an authentication credential values at the authenticating server computing device. The server-computing device will transmit each image of the images collection having a unique credential value representation to the client-computing device using a network protocol. At the client-computing device, the images collection representations are displayed using a standard web browser on which a user may click on individual image of the images collection using standard mouse clicks, other pointing devices, touch screen, etc (henceforth called mouse clicks). These mouse clicks are captured and transmitted as a sequence of credential values from the client computer to the server computer using a network protocol. After receiving the sequence of credential values from the client device over the network protocol, where the sequence of credential values correspond to locations of mouse clicks representing user selections of credential values in an attempted authentication to the user's credential at the server computer; the server computer device is operated to verify that the sequence of credential values corresponds to a correct authentication user's credential by mapping the locations of the mouse clicks to the locations of the randomly placed images collection on the client device's screen. The credential values can be the actual credential value originally assigned to each image and stored at the server computer or the server computer can assign virtual credential values for the duration of the user's authentication session and have them mapped to each of the original credential values stored at the server computer.

The process of randomized images collection for the purpose of a user login in to a server computing device and using a user image's credential involves a first page where a user will enter some kind of user's ID and it will be sent to the server computing device where the user intends to login, then a new page will be transmitted from the server computing device to the client computing device and once it is received and loaded, it will have a randomized images collection. The new page may be a page based frame like “<iframe . . . >”, a new HTML frame, a brand new page, a page based window, pop up, etc., also, the randomized images collection page will be transmitted back and forth over the network protocol using a secure connection like HTTPS, the user ID page may or may not use a secure connection as well.

A set of images collection are used as a user's credentials on a randomized keypad and a virtual set of credential for mapping with the actual user's credentials. We will be using a randomized images collection (keypad) for our examples in explaining its use for entering a user's credentials (it can be used for other purposes as well, as we'll see later on), the keypad can be a combination of images, images and keys of the alphabet, images with values rendered on them or any other means that can be used for the same purpose. Every time a page is sent to a user requesting a user's credential, the images of the numeric keypad will be randomized and the underlying user's credential will be virtualized and randomized as well. The user will use the mouse (other means can be used as well) to click over the image or over the keys of the alphabet, then the selected randomized virtual credentials will be sent to a client-side JavaScript (computer language used to interface HTML elements with other part of the HTML object on a client computer) routine and it will store it sequentially in a form element.

By using this method two types of security will be achieved, spyware (if one happens to be installed in the user's computer without the user's permission) will not be able to have the correct user selection because the keypad position changes every time a page is loaded [1] and phishing will not be able to fool the user because the user images collection must be present at the keypad [2].

Since spyware reads user's keyboard typing and user's mouse click interactions, by having the images collection along with the user's images credential randomized, their position will change every time a page is loaded becoming meaningless to someone trying to steal user's information. Furthermore, since the images that are randomized on the screen are part of the images collection known only to the user, phishing will not be able to fool the user into using a fake website since it will not know the user's chosen images nor their underlying credential values.

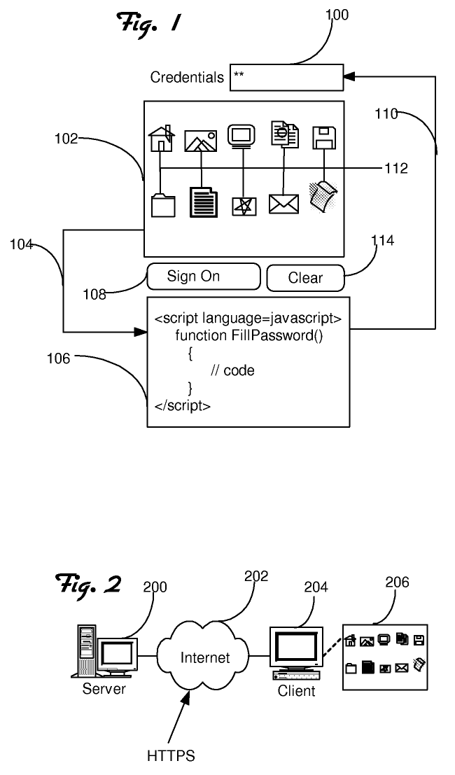

Lets now proceed and explain a preferred embodiment of this invention. As we turn to FIG. 1 it is a preferred embodiment of this invention and it has at the top a credential box 100 (it can be used for other purposes as well, like but not limited to: social security numbers, banking account, etc., as we'll see in another preferred embodiment), next the randomized keypad 102, a sign on button 108, a clear button 114 and a JavaScript routine block 106. A user will move the mouse over the randomized keypad 102 and click over an image 112 and its underlying value is sent 104 to the JavaScript function 106. The JavaScript function 106 will place the received value into a hidden form element and place a mark (asterisk or any other symbol) 110 into the credential field 100. Once the user is finished with selecting the credential and hits the sign on button 108 the information at the credential form field and any other present form fields (if any) will be sent to the server and it will process the received credential and match it with the user's virtual credential or with the actual user's credential, if it is the correct one the user is authenticated; otherwise, the user will be met with a denial. Not all the code for this interaction is present on FIG. 1, they are present on subsequent figures and once explained its full meaning will be readily appreciated for those skilled in the art.

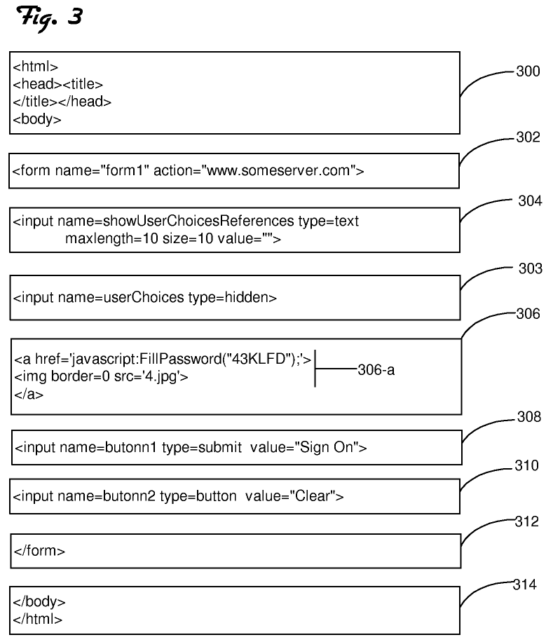

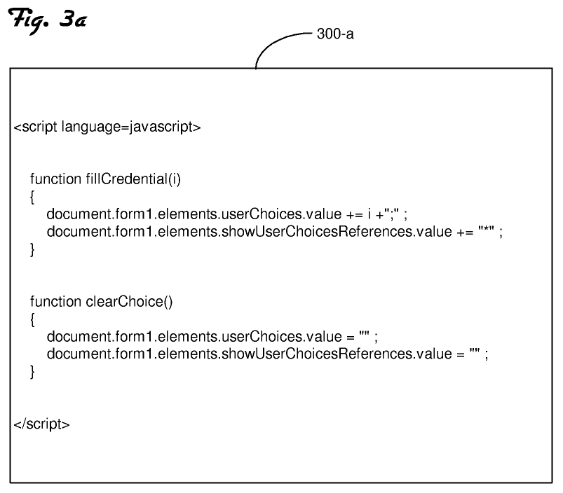

As we turn to FIG. 2 it illustrates a communication between a server computer and client computer over the Internet or over a network and it can be over a HTTP (Hyper Text Transfer Protocol) or HTTPS protocol. It is well understood to those skilled in the art that client computer is any device that is connect to another device (server), also, it means a device that does the interaction between a user accessing the backend device (server). A server is any device that supplies data to a requesting device (client), it can be a computer serving a website, a bank computer serving clients financial data, a health provider computer serving clients health data, etc. As in the arrangement of FIG. 2 a user at a client computer 204 initiates a request for a login page from server computer 200 through a network communication protocol like the Internet or other network 202. Server computer 200 receives the request and process a software programming code and the programming code generate a page having a randomized keypad with user supplied/selected images and key values then sends the page through the network protocol 202 to the client computer 204, the client computer 204 receives and displays the page with the randomized keypad at a display means 206. It is clear to those with the skill in the art that the client computer and the server computer each has at least one or more of the following: a storage unit like a disk unit, a memory bank for storing data and executing program code, a communication card like a modem, display means like a screen, input device like a keyboard, a pointing device like a mouse or a pen, etc. Other devices can be present as well, each may have all the listed devices, more than the listed devices, or less than the listed devices, also, not all devices are listed here and the short list is for reference only and not intended to be constraining to the overall explanation of this invention. The same arrangement of FIG. 2 can be used for a user supplying images to the server computer or selecting pre-existing ones as well, once the server computer receives the images from the client computer it will save them accordingly and if the rendering of values to images is part of the process, it will be done so to each of the user supplied/selected image and save them as well. It is known to those with the skill in the art that server computer 200 is located at the same domain that is listed on the “action” element 302 of FIG. 3 and as for this example; the server computer is called “www.someserver.com” which is a fictitious name.

For our exemplary illustrative disclosure of this invention we will be using a client-computing device and a server-computing device in the process of using the randomized images collection for the purpose of a user at a client-computing device to login to a server-computing device. As it is well known to those of the skill in the art this is but one way of using this invention and as it becomes apparent, this invention can be used at a single computing device as well. In the case of a single computing device, the software element part doing the interfacing to a user is like the client-computing device and the underlay software element doing the authentication is like the server-computing device. The same is true for a user providing and/or selecting the images collection along with the user credentials.

Henceforth follows and explanation of using one or more computing device for the purpose of authenticating a user using the randomized images keypad user credential. At least a first computer having a first software element embedded on at least one tangible media on the first computer and the first software element doing the hosting a plurality of images on the at least first computing device. The at least first computer having at least one resource for a authenticated user to access and a display means for displaying each image of the randomized images for the user's credential and each image having an associated value and the associated values are managed by the first software element. At least one value of the associated values of at least one image of the plurality of images is a user authenticating value for a user to be authenticated by the first software element before allowing access to the at least one resource of the at least first computer—the values associated with the group of images can be a second set of virtual values or the actual values assigned to each image by the at least first computer. At least one user and the value of at least one image is a value for the at least one user to be authenticated by the first software element.

A second software element embedded on at least one tangible media and the second software element having means to initiate a request for a permission from the first software element for the at least one user to access the at least one resource of the at least first computer. In reply to the request from the second software element, the first software element formats a page and the formatted page having a plurality of images randomized as a keypad for the at least one user to make a selection, then transmit the formatted page to the second software element. Once the second software element receives and displays on the display means the formatted page having the randomized images keypad for the at least one user to make a selection.

The at least one user selects at least one image part of the plurality of randomized images keypad displayed on the display means by clicking over on at least one image (the means for clicking over can be but not limited to: mouse click, pen, any pointing device, touch screen, etc.), next, the value corresponding to the at least one user's selection and associated with said user selected image is sent to the first software element by said the software element, then the first software element receives the at least one user's selection value from the second software element and match the at least one user's selection value with the user authenticating value managed by the first software element and assigned to the at least one user.

Finally, if the received selection value that was selected by the at least one user is a exactly match to the user authenticating value assigned to the at least one user and managed by the first software element, the at least one user is authenticated by the first software element and allowed to use the at least one resource of the at least first computer.

As it has been stated throughout our exemplary description of this invention, we've said at least a first computer and that means that one or more computers may be part of the processing of this invention. I can be one computer having both software element, it can be two computer each having one software element and one software element doing the user's interaction is the client computer and the another software element doing the user's authentication is the server computer.

Lets keep FIG. 1, FIG. 3 and FIG. 3a handy and as we turn to FIG. 3 it illustrates snippet of the HTML code that will be present at the user client web browser and processed by the browser therefore. The top block 300 is the first block of tags indicating that the document is HTML and it ends at block 314. The form tag 302 is the tag that will redirect the web browser to the location indicated at its action element and it is “www.somerserver.com”, if the action tag is not present any time the submit button is depressed the page will simple reload, this action will be initiated once a user presses the button 108 of FIG. 1. The input tag 304 is the same credential field 100 of FIG. 1. The following block 306 shows a link 306-a for one image of the images collection of 112 of FIG. 1. Next block 308 is the button 108 of FIG. 1. Next block 310 is the clear button 114 of FIG. 1 and it is used to clear the user's selections and to clear the credential field 100 of FIG. 1. The next block 312 is the ending form tag for the form tag 302. Now FIG. 3a illustrates two JavaScript functions used by the browser to communicate with the HTML code for the user's selection of the randomized keypad 306 of FIGS. 3 and 102 of FIG. 1 and the credential text field 304 of FIGS. 3 and 100 of FIG. 1. As for the block 306 of FIG. 3 just one link for the credential “43KLD” which is the forth key represented by the image “4.jpg” is shown without any formatting tag, it was done as is for sake of simplicity and not intended to obscure the meaning and use of this invention.

Lets review the JavaScript function 300-a of FIG. 3a and it illustrates a “function FillCredential(i)” and it is a function to receive the user selected value from the user interaction 306 of FIG. 3 and keypad 102 of FIG. 1. The line “document.form1.elements.userChoices.value+=i+“;”;” indicates that the value received by the function (the user selection) will be placed at a hidden form field 303 of FIG. 3 and each credential separated by the “;” sign. The next line “document.form1.elements.showUserChoicesReferences.value+=“*”;” simply places a “*” at field 100 of FIG. 1 (304 of FIG. 3) to indicated that a image credential was selected, this field is optional and may or may not be present, it is simply for the purpose of GUI (Graphic User Interface) with the user. The other two tags “{” and “}” indicates the start and end of the function body and it is well known to those of the skill in the art. As for “function clearChoice( )” it the user interfacing with code block 310 of FIG. 3, 100 of FIG. 1 and the button 114 of FIG. 1 and to clear the “document.form1.elements.userChoices.value” form field 303 of FIG. 3.

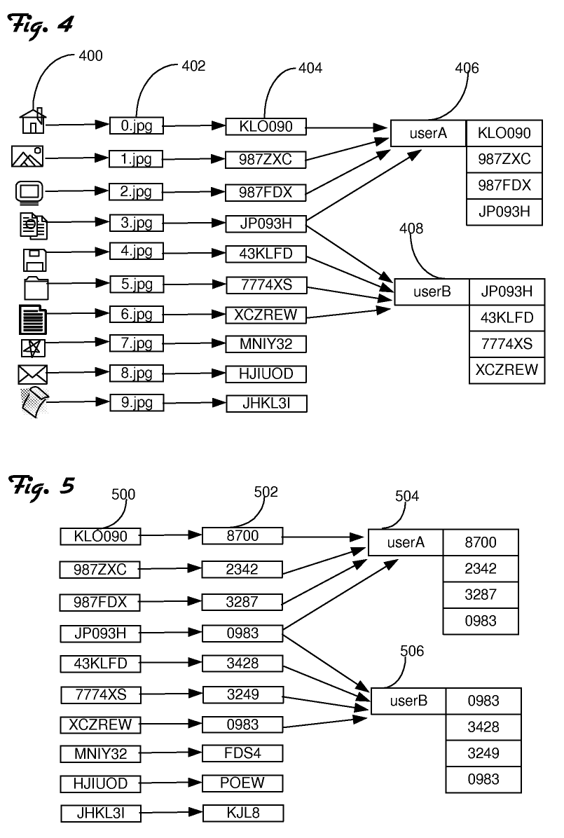

As we turn to FIG. 4 it illustrates a structure of images collection and how they are arranged at the server. Each image 400 is saved on the server and in this case they are 0.jpg to 9.jpg 402, they can be any given name or server generated name. Each image 400 is associated with a user credential 404 and it can be of any value automatically assigned by the server to each user at the moment a user chooses them (images) from the server or when a user uploads them (images) to the server and the server updates the user's credentials and saves the images accordingly thereon, they can be user provided as well. Lets further explore a user credential mechanism. As we look to the right of the FIG. 4 we see two users, userA 406 and userB 408. UserA 406 has 4 images credentials assigned to, and they are: “KL0090”, “987ZXC”, “987FDX” and “JP093H”; userB 408 has “JP093H”, “43KLFD”, “7774XS” and “XCZREW”. As we look to both users they both have in common a credential “JP093H” and in this case the images collection 400 are located at and provided by the server, in this case, both users selected the image credential “3.jpg” and it is the credential “JP093H”.

As per this example we see that any user can select any combination of image credentials in any conceivable way or upload their own image to server for the purpose of creating their personal images credentials (it can be a combination or user uploaded and user selected images as well). We've presented user's credentials with six bytes in length; they can be any length (number of bytes) including a single byte value. E.g. a user selects images for the user's image credential “4.jpg”, “1.jpg”, “8.jpg” and “0.jpg” and the underlying user's credential values might be “X7SL”, since the underlying value does not necessarily represents the user selected values randomized on the client computer screen. In the case of a single byte value the value that is sent to the browser along with the randomized images can be the value representation of the byte value and not necessary the byte itself. E.g. the value for a byte value of “0” has its ASCII (American Standard Code for Information Interchange) value of “48” and “48” would be sent instead of the value of “0”; and “1” is “49”, “2” is “50”, etc.

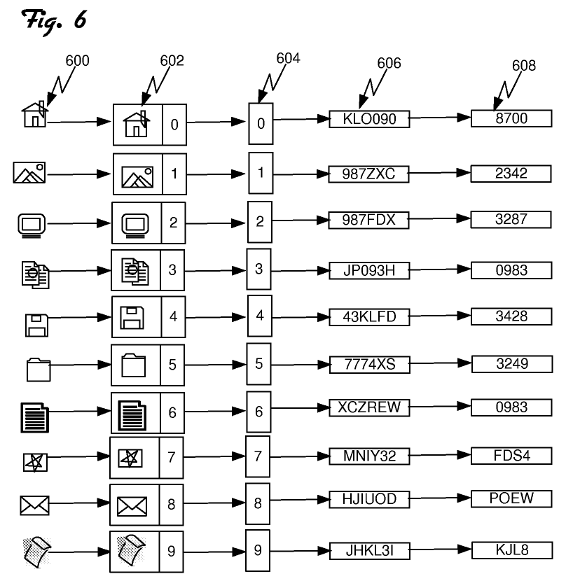

As we turn to FIG. 5 it is a further embodiment of FIG. 4 and illustrates a way to make each of the user's chosen credential virtual and it will further increase security, for instance, making the actual user's credential hidden from anyone trying to guess them. By creating virtual credentials it will be like if a user is choosing different new set of credentials every time a page is requested. As we turn to FIG. 5 the first row 500 is the same credential row 404 of FIG. 4 and the next row 502 is the virtual row, one for each image credential in the group (10 in this case, but it can be any number) including the user's chosen credentials. The userA 504 is the same userA 406 of FIG. 4 and having the same credentials, except as in this case, it is using the virtual credentials instead and they are the ones sent to the client computer where the user is to login in. The set of the virtual credentials will be saved in the server's memory and it can be in a session variable or any other means for the same purpose and for the duration of the user's interaction (session) with the server computer. Once the user selects his/her credentials and they are sent to and received by the server, the server will authenticate them against the virtual ones and if they are the correct ones the server will authorize the user to use the server's resources.

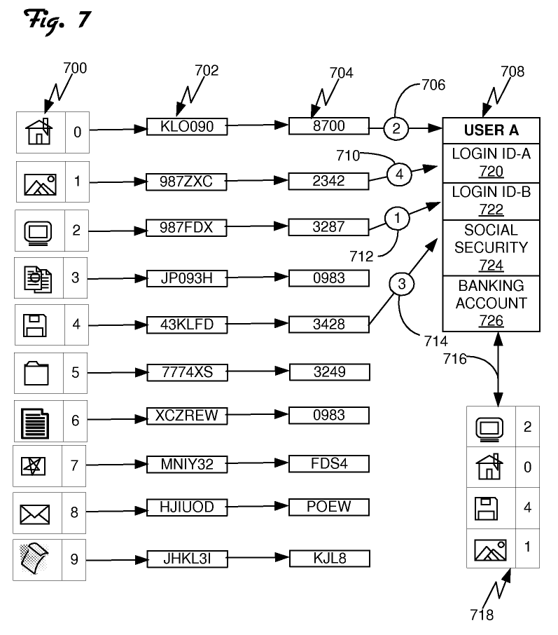

There are more than one-way of using the randomized images credentials for the purposed of offering a secure login mechanism for users to login into a computer over a network or over the Internet. So far, we've shown only images being used, but it can be a combination of images and characters of any alphabet or just characters, or have the characters rendered onto each image part of the collection and including the user's chosen ones. It will work the same way, since the underlying value is used for the login process and the images, characters, etc., are used for the purposed of user's assimilation with what is memorable the each user and part of the GUI (Graphical Users Interface). As we turn to FIG. 6 it illustrates just what we've discussed. The images 600, images and characters 602, characters only 604 along with each images credentials values 606 and each virtual credential 608.

The present invention using randomized images credentials is far superior to any other means of users login, since each user's credential is based on a number of images and these images are part of a greater group of images and since the image group and the user's chosen images are randomized at each time a login page is requested, it will provide a great number of combinations thus making any guessing attempt close to impossible. For instance, if there are ten images and a particular user selects 4 images as his/her credential, it will be a total of ten thousand combinations (10⁴), now if a user selects 6 images it will have one million combinations (10⁶). Since anyone trying to crack the credentials he/she would have to get hold of the user's ID and get to the user's login page then try all the user's credentials values therefore. As we know, the user's credentials are virtual and the actual credential values are not revealed, a different set of virtual credentials are generated at each time a login is tried, thus, making it impossible for second guesses.

As we already know its superiority and it's definite high security compared to any other login means, it has yet many more advantages that can be readily appreciated for those of the skill in the art. Lets proceed and present one more example to further illustrate its many uses. As we turn to FIG. 7 it illustrates a row with images and characters (number in this example) 700, the actual credential values 702, the virtual credential 704 and one user, USER A 708. Now userA 708 has LOGIN ID-A 720, LOGIN ID-B 722, SOCIAL SECURITY 724 and BANKING ACCOUNT 726. All four login having a single user's credential 718 assigned (arrow 716) to USER A 708 and for the purpose of this example they are “3287” 712, “8700” 706, “3428” 714 and “2342” 710. These login accounts can be at different locations and if USER A 708 uploads his/her own images then he/she can select only on set of image credential for all accounts and in the case of a social security and a banking account, the system can be arranged in a way that the actual social security and the banking account be assigned images credentials and once they are required to be selected by the USER A 708 all the USER A 708 will need to do is to select the credential associated with each one and have the system authenticate the credential with the actual social security and banking account. It is well known to those of skill in the art that the same means can be used for substituting any type of identification with a user's chosen credentials and it can be but not limited to: credit card numbers, driver's license, any sensitive information, etc. These examples are not to be construed as limiting this invention or its use, the information and examples provided are only for the purpose of conveying its uses and to clarify it's meaning to those of the skill in the art.

The actual credential values for each user's login account will be different and not necessarily the ones illustrated at FIG. 7 (702 and 704) since each account resides at a different server location and each server will generate or allow users to create distinct values for the user login credential account. In the case a user chooses to upload images for each account at different servers, the user will then provide the same set of images and select the same image for the credential, thus, providing a single images collection and a single user credential to various server computing devices at various locations.

### CONCLUSION

A method of a randomized images collection/keypad for a user to provide sensitive information at an insecure client device for the objective of authenticating the user to the server device and for thwarting spyware and phishing attacks has been presented in its fullness for the purpose of conveying its meaning and mode of uses to those of the skill in the art.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A authenticating means for a user to access a computing device, comprising:
at least a first computer having a first software element embedded on at least one tangible media on said first computer, said first software element hosting a plurality of images;
said at least first computer having at least one resource for a authenticated user to access;
a display means;
each image of said plurality of images having an associated value, said associated values of said plurality of images are managed by said first software element;
at least one value of said associated values of at least one image of said plurality of images is a user authenticating value for a user to be authenticated by said first software element before said first software element allowing a user access to said at least one resource of said at least first computer;
at least one user;
said at least one image having said value for a user to be authenticated by said first software element is assigned to said at least one user;
a second software element embedded on at least one tangible media, said second software element having means to initiate a request for a permission from said first software element for said at least one user to access said at least one resource of said at least first computer;
in reply to a request from said second software element, said first software element formats a page and said formatted page having said plurality of images randomized as a keypad and each image having said associated value then transmit said formatted page to said second software element;
said second software element receives and displays on said display means said formatted page having said randomized images keypad for said at least one user to make a selection;
said at least one user selects at least one image of said plurality of randomized images keypad displayed on said display means by clicking over on said at least one image;
the value corresponding to said at least one user's selection and associated with said user selected image is sent to said first software element by said second software element;
said first software element receives said at least one user's selection value from said second software element and match said at least one user's selection value with said user authenticating value managed by said first software element and assigned to said at least one user; and
if said received selection value that was selected by said at least one user is a exactly match to said user authenticating value assigned to said at least one user and managed by said first software element, said at least one user is authenticated by said first software element and allowed to use said at least one resource of said at least first computer.

2. The authenticating means according to claim 1 wherein at least one image of said plurality of images was provided by said at least one user to said at least first computer.

3. The authenticating means according to claim 1 wherein at least one image of said plurality of images was selected by said at least one user from said at least first computer.

4. The authenticating means according to claim 1 wherein at least one value of said plurality of values associated with said plurality of images was generated by said at least first computer.

5. The authenticating means according to claim 1 wherein at least one value of said plurality of values associated with said plurality of images was provided by said at least one user to said at least first computer.

6. The authenticating means according to claim 1 wherein at least one image of said plurality of images having at least one character rendered on it.

7. A authenticating means for a user to access a computing device, comprising:
at least a first computer having a first software element embedded on at least one tangible media on said first computer, said first software element hosting a plurality of images;
said at least first computer having at least one resource for a authenticated user to access;
a display means;
each image of said plurality of images having a first set of associated value;
said first software element associates a second set of distinct values to each value of said first set of values associated with said plurality of images;
both set of values are managed by said first software element;
at least one value of said second set of associated values is a user authenticating value for a user to be authenticated by said first software
element before said first software element allowing a user access to said at least one resource of said at least first computer;
at least one user;
said at least one value of said second set of values for a user to be authenticated by said first software element is assigned to said at least one user;
a second software element embedded on at least one tangible media, said second software element having means to initiate a request for a permission from said first software element for said at least one user to access said at least one resource of said at least first computer;
in reply to a request from said second software element, said first software element formats a page and said formatted page having said plurality of images randomized as a keypad and each image of said plurality of images having a value of said second set of associated values then transmit said formatted page to said second software element;
said second software element receives and displays on said display means said formatted page having said randomized images keypad for said at least one user to make a selection;
said at least one user selects at least one image of said plurality of randomized images keypad displayed on said display means by clicking over on said at least one image;
the value corresponding to said at least one user's selection and associated with said user selected image is sent to said first software element by said second software element;
said first software element receives said at least one user's selection value from said second software element and match said at least one user's selection value with said user authenticating value managed by said first software element and assigned to said at least one user; and
if said received selection value that was selected by said at least one user is a exactly match to said user authenticating value assigned to said at least one user and managed by said first software element, said at least one user is authenticated by said first software element and allowed to use said at least one resource of said at least first computer.

8. The authenticating means according to claim 7 wherein at least one image of said plurality of images was provided by said at least one user to said at least first computer.

9. The authenticating means according to claim 7 wherein at least one image of said plurality of images was selected by said at least one user from said at least first computer.

10. The authenticating means according to claim 7 wherein at least one value of said plurality of values associated with said plurality of images was generated by said at least first computer.

11. The authenticating means according to claim 7 wherein at least one value of said plurality of values associated with said plurality of images was provided by said at least one user to said at least first computer.

12. The authenticating means according to claim 7 wherein at least one image of said plurality of images having at least one character rendered on it.

13. The authenticating means according to claim 7 wherein said second set of values is virtual values.

14. A method for authenticating a user for use of a server computing device wherein said server computing device is connected by a network to a client computing device, comprising:
in response to a request to access a server computing device the server computing device is operated to generate a images collection placed at random positions, said images collection having images representing said user credential, each image of said image collection corresponding to a possible value of the credential value in an authentication credential value stored at said authenticating server computing device for said user;
transmitting said randomized images collection along with said images representing said user credential and a form field element to receive a user interaction with said images collection representation to said client computing device using a network protocol;
receiving a sequence of location values and said form text field's value from said client computing device transmitted using a network protocol, where said sequence of location values correspond to locations of mouse clicks representing a user selections of credential value in an attempted authentication of said user's credential value; and
verifying that the received form field element's value corresponds to a correct authentication user's credential value by comparing said form field element's value to a predefined user's authentication credential value stored at said server computing device.

15. The method for authenticating a user according to claim 14 wherein at least one image of said images collection was provided by said user to said server computing device.

16. The method for authenticating a user according to claim 14 wherein at least one image of said images collection was selected by said user from said server computing device.

17. The method for authenticating a user according to claim 14 wherein at least one value of said values associated with said images collection was generated by said server computing device.

18. The method for authenticating a user according to claim 14 wherein at least one value of said values associated with each image of said images collection was provided by said user to said server computing device.

19. The method for authenticating a user according to claim 14 wherein at least one image of said images collection having at least one character rendered on it.
